(19) United States
(12) Patent Application Publication
(10) Pub. No.: US 2025/0110617 A1
(43) Pub. Date: Apr. 3, 2025

(54) KEYWORD DETERMINATION

(71) Applicants: Beijing Youzhuju Network Technology Co., Ltd., Beijing (CN); Lemon Inc., Grand Cayman (GC)

(72) Inventors: Kewei Shi, Beijing (CN); Zizhen Wang, Beijing (CN); Deqian Kong, Beijing (CN); Wenting Wang, Singapore (SG); Suhui Wu, Beijing (CN); Jingwei Liu, Beijing (CN); Yan Li, Beijing (CN); Ziqi Ruan, Beijing (CN); Qizhao Chen, Beijing (CN)

(21) Appl. No.: 18/981,339

(22) Filed: Dec. 13, 2024

(51) Int. Cl. G06F 3/0482; G06F 16/2457; G06F 16/953; G06V 10/77; G06V 10/80

(52) U.S. Cl. CPC G06F 3/0482; G06F 16/24578; G06F 16/953; G06V 10/7715; G06V 10/806

(57) ABSTRACT

Embodiments of the present disclosure provide a solution for keyword determination. A method includes: presenting an interface comprising a plurality of information fields associated with an object; in response to detecting completion of input in a first information field among the plurality of information fields, determining at least one candidate keyword for the object based on first information input in the first information field, the first information comprising at least one of: text or visual information; and presenting the at least one candidate keyword for selection into at least one of the plurality of information fields. This solution allows efficient and timely keyword determination while the user is editing or modifying the object information.

### FIELD

The present disclosure generally relates to computer technologies, and more specifically, to a method, apparatus, device and computer readable storage medium for keyword determination.

### BACKGROUND

In current networking platforms, optimizing information of an object posted in the network plays an important role in increasing exposure of the object to more people. Search engine friendly keywords may be generated by combining keywords for search engine optimization (SEO) with titles and related information of a product, and thus search rankings of the object may be improved. However, related works for keyword recommendation have limitations in some aspects, such as poor real-time performance, inaccurate recommendation results and the like.

### SUMMARY

In a first aspect of the present disclosure, there is provided a method of keyword determination. The method comprises: presenting an interface comprising a plurality of information fields associated with an object; in response to detecting completion of input in a first information field among the plurality of information fields, determining at least one candidate keyword for the object based on first information input in the first information field, the first information comprising at least one of: text or visual information; and presenting the at least one candidate keyword for selection into at least one of the plurality of information fields.

In a second aspect of the present disclosure, there is provided an apparatus for keyword determination. The apparatus comprises: an interface presenting module configured to present an interface comprising a plurality of information fields associated with an object; a keyword determining module configured to, in response to detecting completion of input in a first information field among the plurality of information fields, determine at least one candidate keyword for the object based on first information input in the first information field, the first information comprising at least one of: text or visual information; and a keyword presenting module configured to present the at least one candidate keyword for selection into at least one of the plurality of information fields.

In a third aspect of the present disclosure, there is provided an electronic device. The electronic device comprises: at least one processing unit; and at least one memory coupled to the at least one processing unit and storing instructions executable by the at least one processing unit, the instructions, upon execution by the at least one processing unit, causing the electronic device to perform: presenting an interface comprising a plurality of information fields associated with an object; in response to detecting completion of input in a first information field among the plurality of information fields, determining at least one candidate keyword for the object based on first information input in the first information field, the first information comprising at least one of: text or visual information; and presenting the at least one candidate keyword for selection into at least one of the plurality of information fields.

In a fourth aspect of the present disclosure, a computer-readable storage medium is provided. The computer-readable storage medium stores computer executable instructions which, when executed by an electronic device, causes the electronic device perform operations comprising: presenting an interface comprising a plurality of information fields associated with an object; in response to detecting completion of input in a first information field among the plurality of information fields, determining at least one candidate keyword for the object based on first information input in the first information field, the first information comprising at least one of: text or visual information; and presenting the at least one candidate keyword for selection into at least one of the plurality of information fields.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of an interface in which candidate keywords are provided in accordance with some embodiments of the present disclosure;

FIG. 3 illustrates a schematic architecture of a machine learning model of determining a candidate keyword(s) in accordance with some embodiments of the present disclosure;

FIG. 4 illustrates a schematic diagram of inputting a selected keyword into an information field in accordance with some embodiments of the present disclosure;

FIG. 5 illustrates a schematic diagram of an example process of keyword determination in accordance with some embodiments of the present disclosure;

FIG. 6 illustrates a flowchart of a process for keyword determination in accordance with some embodiments of the present disclosure;

FIG. 7 shows a block diagram of an apparatus for keyword determination in accordance with some embodiments of the present disclosure; and

FIG. 8 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

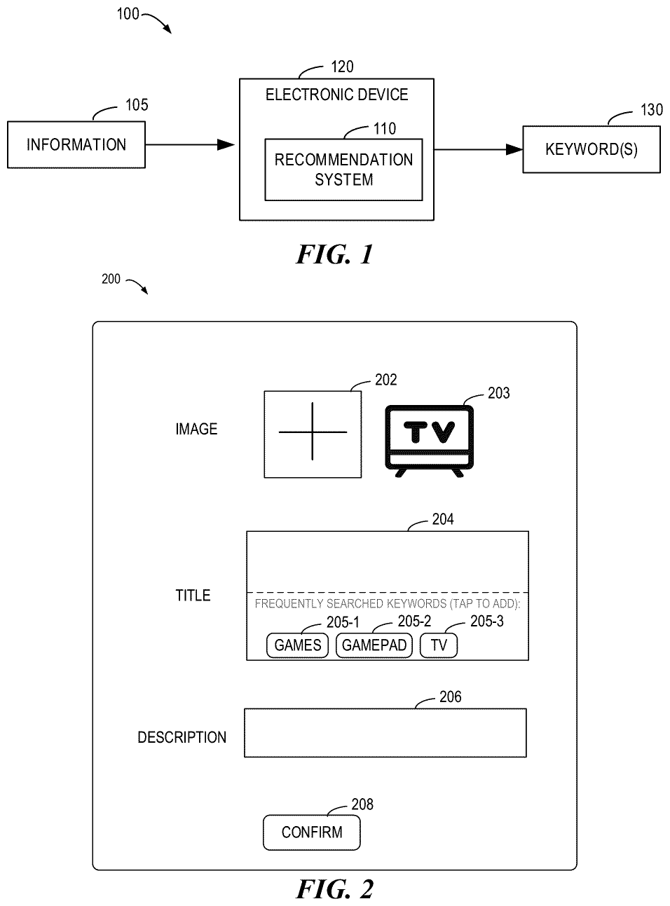

FIG. 1 illustrates a block diagram of an example environment 100 in which various embodiments of the present disclosure may be implemented. In the environment 100, an electronic device 120 includes or is deployed with a recommendation system 110. The recommendation system 110 is configured to recommend one or more keywords 130 for an object based on information 105 of the object. In some embodiments, the information 110 of the object may include at least one of: an image of the object, a title of the object or a description of the object.

In some embodiments, the object may include a product or co commodity posted or to be posted on an e-commerce platform. Alternatively, or in addition, the object may include a personal work e.g., a video, an article or an image posted or to be posted on a social networking platform. Alternatively, or in addition, the object may include an e-book, or a podcast posted or to be posted on e-book application or audiobook application. Alternatively, or in addition, the object may an application released or to be released on an application store.

In some embodiments, the keyword(s) 130 for the object, if selected as a part of information of the object, may be applied in the SEO scenario and the search ranking of the object may be improved based on the keyword(s) 130.

In the environment 100, the recommendation system 110 may include any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As briefly mentioned above, related works for keyword recommendation have limitations. To be specific, conventional SEO recommendation systems usually need to wait for a user (e.g., merchant) to complete title input, category selection, and image upload before recommending keywords, which is difficult to meet the requirements of e-commerce platforms for quick response. Most conventional recommendation algorithms are based on textual information and ignore the visual information in images, such as color, shape of the object, etc. These key information are not effectively utilized, resulting in inaccurate recommendation results. This problem is more prominent in the actual user journey. For example, the user usually enters the title first, however, due to the lack of effective multimodal fusion technology, the coverage of recommended SEO words is limited by relying only on preliminary information.

Furthermore, conventional recommendation systems have limited understanding of features of an object, and the generated recommendation words do not match the object well, which results in low relevance or redundancy. In international e-commerce platforms, there are significant differences in the demand for SEO keywords among different languages. Conventional recommendation systems lack the ability to understand and map cross linguistic semantics, making it difficult to generate high-quality SEO keywords that are suitable for different language markets.

Embodiments of the present disclosure propose an improved solution of keyword determination. In this solution, an interface comprising a plurality of information fields associated with an object is presented. In response to detecting completion of input in a first information field among the plurality of information fields, at least one candidate keyword for the object is determined based on first information input in the first information field. The first information comprises at least one of: text or visual information. The at least one candidate keyword is presented for selection into at least one of the plurality of information fields.

With these embodiments of the present disclosure, while a user is editing or modifying the object information, dynamic and efficient keyword determination may be enabled. In this way, the real time performance of keyword determination may be improved as the recommended keywords are determined based on the newly input information. The user may always be provided with the most suitable keywords for selection based on the input information.

Example embodiments of the present disclosure will be described with reference to the drawings.

FIG. 2 illustrates a schematic diagram of an interface 200 in which candidate keywords are provided in accordance with some embodiments of the present disclosure. As shown in FIG. 2, an interface 200 comprising a plurality of information fields associated with an object is presented. In some examples, the object may be a product, a video, a piece of news and the like.

In some embodiments, the plurality of information fields may include at least one of: a title field 204 for the object, or a description field 206 for the object. In some examples, the title field 204 may be used to quickly convert the main information of the object and may include a name of the object. The description field 206 may be used to provide detailed information of the object and may include frequently asked questions for the object. In a case where the object is clothes, the title field 204 may include, e.g., “a good t-shirt” input by a user (e.g., e-commerce merchant).

In some embodiments, the plurality of information fields may include one or more information fields for inputting visual information. The visual information may comprise at least one of the following: at least one image, or at least one video clip. As shown in the example of FIG. 2, the plurality of information fields may include an image field 202 for the object. In some examples, the user may upload an image of the object in the image field 202.

In some embodiments, the object may represent a commodity, and the plurality of information fields may be required for post of the commodity into an online store. In some examples, the plurality of information fields may include a title field, a description filed, a category filed, an attribute filed, a material field, a safety information filed, a return policy field and the like. In order to post the commodity, the user may input information related to the commodity into the plurality of information fields.

In some embodiments, the object may represent a personal work e.g., including a video, an article, an image and the like. The plurality of information fields may be required for post of the personal work on a social network platform. In some examples, the plurality of information fields may include a title field, a tag field, a thumbnail field, a copyright information filed and the like.

In some embodiments, after confirmation of the input information for the object, at least part of information received in the plurality of information fields may be presented in association with the object. In some examples, after clicking a confirm button 208, an image received in the image field 202, a title received in the title field 204 and description information received in the description field 206 may be presented in association with the object.

After the interface is presented, in response to detecting completion of input in a first information field among the plurality of information fields, at least one candidate keyword for the object is determined based on first information input in the first information field. The first information comprises at least one of: text or visual information. In some examples, when an image 203 (as an example of the first information) is uploaded in the image filed 202 (as an example of the first information field) and information is not input in the title field 204, at least one candidate keyword 205-1 to 205-3 may be determined based on the image 203. Furthermore, the at least one candidate keyword 205-1 to 205-3 may be presented in the title field 204 for selection into the title field 204. In this way, keywords may be returned timely once the user completes inputting information in an information field.

In some embodiments, the information (e.g., an image, a title, a description of the object) input by the user may be captured and the input status of a user may be continuously monitored. When the input is completed, a recommendation may be performed based on the latest input information.

In some embodiments, if a cursor moves from the first information filed to the second information filed, the input in the first information filed may be determined as completed. Alternatively, or in addition, if an image is uploaded in an image field, the input in the first information filed may be determined as completed. Alternatively, or in addition, if information is not input into an information filed where a cursor stays for a predetermined time, the input in the first information filed may be determined as completed.

In some embodiments, if the plurality of information fields comprises a first field for visual information and at least one second field for text, the at least one second field may be available for input after visual information is received in the first field. As the keyword determination are usually provided for text fields, by allowing the user to input the visual information first, keyword determination may be provided to the following text fields based on the previously received visual information. Such setting may further facilitate the information inputting and editing process for the user. In some examples, if a user completes inputting a object name (as an example of the second information) for the object in the title field 204 (as an example of second information field), at least one candidate keyword for the object may be determined based on the object name and previously input visual information.

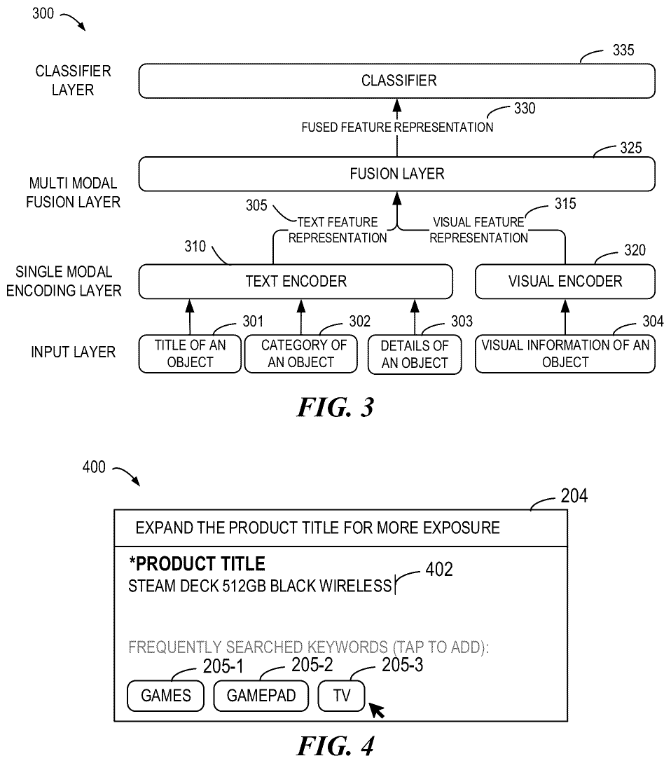

In some embodiments, a trained machine learning model may be applied to determine the at least one candidate keyword based on the currently available input information for the object. FIG. 3 illustrates a schematic architecture of a machine learning model 300 of determining a candidate keyword(s) in accordance with some embodiments of the present disclosure.

In some embodiments, the information used to determine the at least one candidate keyword may comprise either one or both the text and the visual information. The following will describe the process of determining at least one candidate keyword based on the information with reference to FIG. 3.

As shown in FIG. 3, a text feature representation 305 of a text may be extracted by a text encoder 310. A visual feature representation 315 of visual information of an object 304 may be extracted by an image encoder 320. In some examples, the text may include a title of an object 301, a category of the object 302 and details of the object 303 The visual information 304 may include an image of the object In some embodiments, if the information only comprise one of the text or the visual information, only one of the text encoder 315 or the visual encoder 320 may be used to extract corresponding feature representation. It is to be noted that the text encoder 310 may employ any text processing models that can extract text feature representation and the image encoder 320 may employ any image processing models that can extract visual feature representation.

After the text feature representation 305 and the visual feature representation 315 are extracted, a fused feature representation 330 for the object may be determined by fusing the text feature information 305 and the visual feature information 315 at a fusion layer 325. Then, at least one candidate keyword may be determined based on the fused feature representation by a classifier 335. In some examples, the fused feature representation 330 may represent the integrated representation of feature information derived from different modalities (e.g., text and visual information). With these embodiments, the fused feature representation 330 may capture the inherent connections between text and visual information, and thus multimodal information may be better understood and processed. In this way, multidimensional features of the object may be fully explored and thus the accuracy and relevance of the recommend keywords may be improved.

In some embodiments, an attention mechanism may be performed on the text feature representation 305 and the visual feature representation 315, to obtain an interaction matrix between the text feature representation and the visual feature representation. A text weight corresponding to the text feature representation 305 and a visual weight corresponding to the visual feature representation 315 may be determined based on the interaction matrix. In some examples, a co-attention mechanism (or other multimodal interaction methods) may be performed to obtain the interaction matrix, which represents the mutual relationship and associated features between the text and visual information. Then, the text weight and the visual weight represent respective importances of the text and visual information may be determined. In this way, the fusion effect may be optimized, key features may be highlighted, and thus the accuracy of recommended keyword may be improved.

After the text weight and the visual weight are determined, a weighted fusion may be performed on the text feature representation 305 and the visual feature representation 315 based on the text weight and the visual weight, to obtain the fused feature representation 330. In some examples, the text feature representation and visual feature representation after the weighted fusion may be concatenated to form the fused feature representation 330. With these embodiments, recommendation may be performed based on rich information of both the text and the visual information.

In some embodiments, respective similarities between the object and respective keywords in a set of keywords may be determined based on the fused feature representation 330 and respective text feature representations of the respective keywords. Then, the at least one candidate keyword may be determined from the respective keywords based on a ranking result of the respective similarities. In some examples, respective similarities between the object and respective keywords may be determined based on cosine similarity or Euclidean distance between the fused feature representation and respective text feature representations. The respective similarities may be ranked in a descending order. If ten candidate keywords are to be recommended, the first ten keywords in the set of keywords may be determined as the candidate keywords based on the ranking result.

In some embodiments, in the process of determining the at least one candidate keyword, a plurality of candidate keywords may be recalled from different sources. The synonyms in the recall results may be normalized to avoid duplicate recommendations and ensure the diversity and accuracy of the recommendation results. In some examples, by combining the multimodal classification scores and the confidence weights of the recall sources, the final ranking score is calculated to generate a priority list. The at least one candidate keyword may be retrieved from the priority list in order.

In some embodiments, at least part of the set of keywords may be generated by a content generative model. In some examples, the content generative model (e.g., a transformer model) may be used to generate a part of the set of keywords. In this way, insufficient keywords under specific categories may be supplemented.

In some embodiments, the set of keywords may include some popular keywords that are frequently searched in a search engine. Alternatively, or in addition, the set of keywords may include some keywords related to attributes of an object. It would be appreciated that the present disclosure is not limited to the source of the keywords.

In some embodiments, in response to detecting an attribute value input in an attribute filed among the plurality of information fields, the attribute value may be supplemented by using a language model. In some examples, a user inputs “waterproof” (as an example of the attribute value) in a function field (as an example of the attribute filed), “breathable” may be supplemented as a further attribute value in the function field. Then, the at least one candidate keyword may be determined based on the information that is currently input and has been received, and the supplemented attribute value. In some examples, semantic similarities between a text representation of the supplemented attribute and text representations of the set of keywords. The at least one candidate keywords may be determined based on the semantic similarities. In this way, the semantic ambiguity in the set of keywords may be eliminated and the recommendation accuracy may be improved.

In some embodiments, the received input information may comprise the text represented in a first language (e.g., Indonesian). A first text feature representation of the text may be extracted by using a multi-language text encoder. Respective text feature representations of respective keywords in a set of keywords may be extracted by using the multi-language text encoder. The set of keywords may be represented in the first language and a second language (languages other than the first language, e.g., English, Chinese, etc.). In some examples, the multi-language text encoder may extract text feature representations of texts represented in different language. Then, the at least one candidate keyword may be determined based on similarities between the first text feature representation and the respective text feature representations. With these embodiments, candidate keywords represented in different languages may be determined. In this way, recommendation results that are suitable for different markets may be generated.

After the at least one candidate keyword is determined, the at least one candidate keyword is presented for selection into at least one of the plurality of information fields. Reference is now made back to FIG. 2. As illustrated, at least one candidate keyword (e.g., candidate keyword 205-1 to 205-3) is presented for selection into the title filed 204.

In some embodiments, in response to the selection of a candidate keyword, the selected keyword may be input into the at least one of the plurality of information fields. The following will describe inputting the selected keyword into an information field with reference to FIG. 4, which illustrates a schematic diagram 400 of inputting a selected keyword into an information field in accordance with some embodiments of the present disclosure. As shown in FIG. 4, by clicking a candidate keyword 250-3, the selected keyword 250-3 may be inserted into a specified position 402 in the title filed 204. With these embodiments, candidate keywords may be used to expand information of the object. In this way, the ranking of the object in a search engine may be improved.

In some embodiments, in response to detecting completion of input in a second information field among the plurality of information fields, the at least one candidate keyword may be updated based on second information input in the second information field and first information that is previously input in the first information field. Then, the presenting of the at least one candidate keyword may be replaced with presenting of the at least one updated candidate keyword. With these embodiments, candidate keywords may be determined based on currently input information and previously input information. In this way, the accuracy of the recommended keywords may be improved.

In some embodiments, in response to detecting an update of the first information in the first information field, the at least one candidate keyword may be updated based on the updated first information. Then, the presenting of the at least one candidate keyword may be replaced with presenting of the at least one updated candidate keyword. With these embodiments, candidate keywords may be determined in real time based on an update of information of the object.

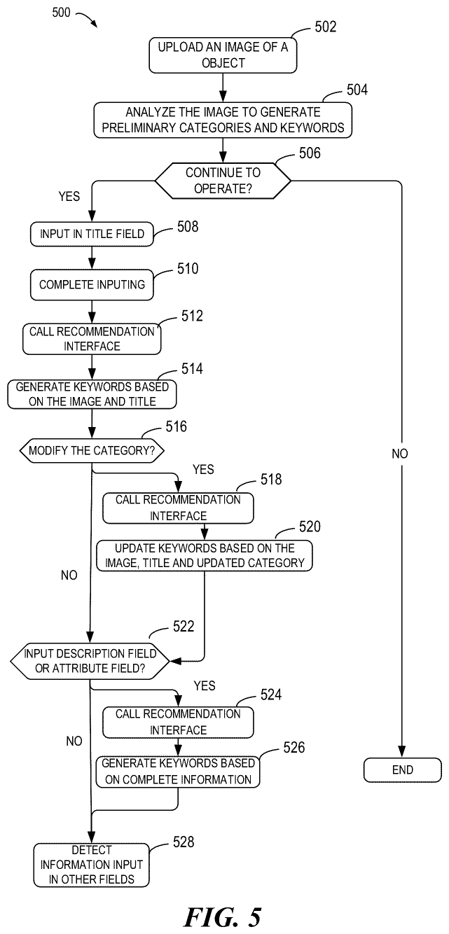

To better understand the solution for keyword determination, a specific example is now described with reference to FIG. 5. FIG. 5 illustrates a schematic diagram of an example process 500 of keyword determination in accordance with some embodiments of the present disclosure. As shown in FIG. 5, at block 502, a user uploads an image of an object. At block 504, a recommendation system may analyze the image to generate preliminary categories and keywords. At block 506, whether the user continues to operate will be detected. If the user continues to operate, at block 508, the user may input information in a title filed. At block 510, the user may complete the inputting. At block 512, a recommendation interface may be called to perform recommendation tasks. At block 514, keywords may be generated based on the image and the title.

At block 516, whether the user modifies the category will be detected. If the user modifies the category, at block 518, the recommendation interface may be called to perform recommendation tasks. At block 520, keywords may be updated based on the image, title and updated category.

At block 522, whether the user inputs information in a description field or an attribute field may be detected. If the user inputs information in a description field or an attribute field, at block 524, the recommendation interface may be called to perform recommendation tasks. At block 526, keywords may be based on complete information input in different field. At block 528, information input in other information fields may be detected. Then, keywords may be updated based on newly input information and previously input information. With these embodiments, keywords are supplemented dynamically based on information input into a further information filed or an updated of the existing information, which ensures more comprehensive recommendation results.

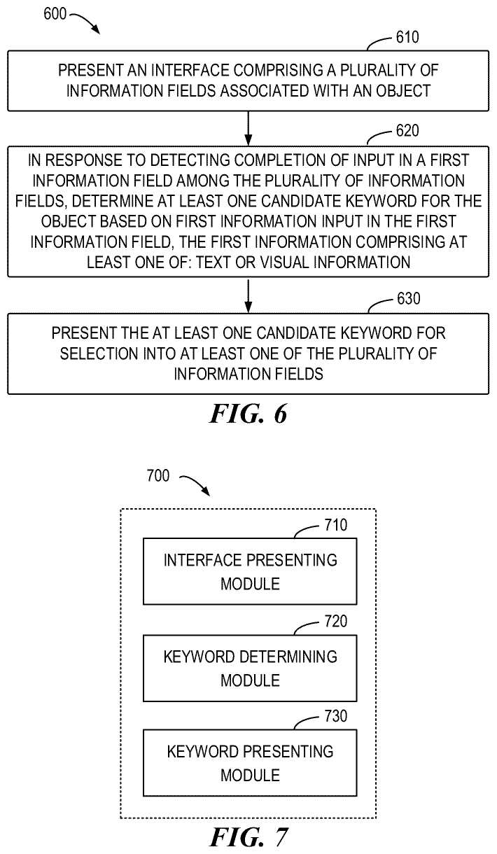

FIG. 6 illustrates a flowchart of a process 600 for keyword determination in accordance with some embodiments of the present disclosure. The process 600 may be implemented at the recommendation system 110 of FIG. 1.

At block 610, the recommendation system 110 presents an interface comprising a plurality of information fields associated with an object.

At block 620, the recommendation system 110, in response to detecting completion of input in a first information field among the plurality of information fields, determines at least one candidate keyword for the object based on first information input in the first information field, the first information comprising at least one of: text or visual information.

At block 630, the recommendation system 110 presents the at least one candidate keyword for selection into at least one of the plurality of information fields.

In some embodiments, the process 600 further comprises in response to detecting completion of input in a second information field among the plurality of information fields, updating the at least one candidate keyword based on second information input in the second information field and the first information; and replacing the presenting of the at least one candidate keyword with presenting of the at least one updated candidate keyword.

In some embodiments, the process 600 further comprises in response to detecting an update of the first information in the first information field, updating the at least one candidate keyword based on the updated first information; and replacing the presenting of the at least one candidate keyword with presenting of the at least one updated candidate keyword.

In some embodiments, the first information comprises both the text and the visual information, and wherein determining at least one candidate keyword comprises: extracting a text feature representation of the text and a visual feature representation of the visual information, respectively; determining a fused feature representation for the object by fusing the text feature information and the visual feature information; and determining the at least one candidate keyword based on the fused feature representation.

In some embodiments, determining the fused feature representation comprises: performing an attention mechanism on the text feature representation and the visual feature representation, to obtain an interaction matrix between the text feature representation and the visual feature representation; determining a text weight corresponding to the text feature representation and a visual weight corresponding to the visual feature representation based on the interaction matrix; and performing a weighted fusion on the text feature representation and the visual feature representation based on the text weight and the visual weight, to obtain the fused feature.

In some embodiments, determining the at least one candidate keyword based on the fused feature representation comprises: determining respective similarities between the object and respective keywords in a set of keywords based on the fused feature representation and respective text feature representations of the respective keywords; and determining the at least one candidate keyword from the respective keywords based on a ranking result of the respective similarities.

In some embodiments, at least part of the set of keywords are generated by a content generative model.

In some embodiments, the process 600 further comprises in response to detecting an attribute value input in an attribute filed among the plurality of information fields, supplementing, using a language model, the attribute value; and determining the at least one candidate keyword comprises: determining the at least one candidate keyword based on the first information and the supplemented attribute value.

In some embodiments, the process 600 further comprises in response to the selection, inputting the selected keyword into the at least one of the plurality of information fields.

In some embodiments, the plurality of information fields comprise at least one of: a title field for the object, or a description field for the object.

In some embodiments, the first information comprises the text represented in a first language and determining the at least one candidate keyword comprises: extracting, using a multi-language text encoder, a first text feature representation of the text; extracting, using the multi-language text encoder, respective text feature representations of respective keywords in a set of keywords, wherein the set of keywords are represented in the first language and a second language; and determining the at least one candidate keyword based on similarities between the first text feature representation and the respective text feature representations.

In some embodiments, after post of the object, a title received in the title field and description information received in the description field are presented in association with the object.

In some embodiments, the plurality of information fields comprises a first field for visual information and at least one second field for text, and wherein the at least one second field is available for input after visual information is received in the first field.

In some embodiments, the object represents a commodity, and the plurality of information fields are required for post of the commodity into an online store.

In some embodiments, the visual information comprises at least one of the following: at least one image, or at least one video clip.

FIG. 7 shows a block diagram of an apparatus 700 for keyword determination in accordance with some embodiments of the present disclosure. The apparatus 700 may be implemented, for example, or included at the recommendation system 110 of FIG. 1. Various modules/components in the apparatus 700 may be implemented by hardware, software, firmware, or any combination thereof.

As shown, the apparatus 700 includes an interface presenting module 710 configured to present an interface comprising a plurality of information fields associated with an object.

The apparatus 700 includes a keyword determining module 720 configured to, in response to detecting completion of input in a first information field among the plurality of information fields, determine at least one candidate keyword for the object based on first information input in the first information field, the first information comprising at least one of: text or visual information.

The apparatus 700 further includes a keyword presenting module 730 configured to present the at least one candidate keyword for selection into at least one of the plurality of information fields.

In some embodiments, the apparatus 700 further comprises a keyword replacing module configured to, in response to detecting completion of input in a second information field among the plurality of information fields, update the at least one candidate keyword based on second information input in the second information field and the first information and replace the presenting of the at least one candidate keyword with presenting of the at least one updated candidate keyword.

In some embodiments, the apparatus 700 further comprises a keyword replacing module configured to, in response to detecting an update of the first information in the first information field, update the at least one candidate keyword based on the updated first information and replace the presenting of the at least one candidate keyword with presenting of the at least one updated candidate keyword.

In some embodiments, the first information comprises both the text and the visual information. The keyword determining module 720 is further configured to extract a text feature representation of the text and a visual feature representation of the visual information, respectively, determine a fused feature representation for the object by fusing the text feature information and the visual feature information and determine the at least one candidate keyword based on the fused feature representation.

In some embodiments, the keyword determining module 720 is further configured to perform an attention mechanism on the text feature representation and the visual feature representation, to obtain an interaction matrix between the text feature representation and the visual feature representation, determine a text weight corresponding to the text feature representation and a visual weight corresponding to the visual feature representation based on the interaction matrix and perform a weighted fusion on the text feature representation and the visual feature representation based on the text weight and the visual weight, to obtain the fused feature.

In some embodiments, the keyword determining module 720 is further configured to determine respective similarities between the object and respective keywords in a set of keywords based on the fused feature representation and respective text feature representations of the respective keywords and determine the at least one candidate keyword from the respective keywords based on a ranking result of the respective similarities.

In some embodiments, at least part of the set of keywords are generated by a content generative model.

In some embodiments, the apparatus 700 further comprises a supplementing module configured to, in response to detecting an attribute value input in an attribute filed among the plurality of information fields, supplement, using a language model, the attribute value. The keyword determining module 720 is further configured to determine the at least one candidate keyword based on the first information and the supplemented attribute value

In some embodiments, the apparatus 700 further comprises a keyword inputting module configured to, in response to the selection, input the selected keyword into the at least one of the plurality of information fields.

In some embodiments, the plurality of information fields comprise at least one of: a title field for the object, or a description field for the object.

In some embodiments, the first information comprises the text represented in a first language. The keyword determining module 720 is further configured to extract, using a multi-language text encoder, a first text feature representation of the text, extract, using the multi-language text encoder, respective text feature representations of respective keywords in a set of keywords, where the set of keywords are represented in the first language and a second language and determine the at least one candidate keyword based on similarities between the first text feature representation and the respective text feature representations.

In some embodiments, after post of the object, a title received in the title field and description information received in the description field are presented in association with the object.

In some embodiments, the plurality of information fields comprises a first field for visual information and at least one second field for text. The at least one second field is available for input after visual information is received in the first field.

In some embodiments, the object represents a commodity, and the plurality of information fields are required for post of the commodity into an online store.

In some embodiments, the visual information comprises at least one of the following: at least one image, or at least one video clip.

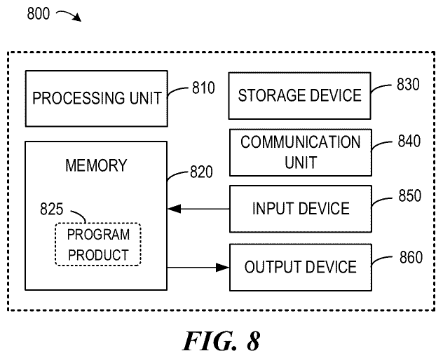

FIG. 8 illustrates a block diagram of an electronic device 800 in which one or more embodiments of the present disclosure can be implemented. It would be appreciated that the electronic device 800 shown in FIG. 8 is only an example and should not constitute any restriction on the function and scope of the embodiments described herein. The electronic device 800 may be used, for example, to implement the recommendation system 110 of FIG. 1. The electronic device 800 may also be used to implement the apparatus 700 of FIG. 7.

As shown in FIG. 8, the electronic device 800 is in the form of a general computing device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and can execute various processes according to the programs stored in the memory 820. In a multiprocessor system, multiple processing units execute computer executable instructions in parallel to improve the parallel processing capability of the electronic device 800.

The electronic device 800 typically includes a variety of computer storage medium. Such medium may be any available medium that is accessible to the electronic device 800, including but not limited to volatile and non-volatile medium, removable and non-removable medium. The memory 820 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 830 may be any removable or non-removable medium, and may include a machine-readable medium, such as a flash drive, a disk, or any other medium, which can be used to store information and/or data (such as training data for training) and can be accessed within the electronic device 500.

The electronic device 800 may further include additional removable/non-removable, volatile/non-volatile, transitory/non-transitory storage medium. Although not shown in FIG. 8, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 825, which has one or more program modules configured to perform various methods or acts of various embodiments of the present disclosure.

The communication unit 840 communicates with a further computing device through the communication medium. In addition, functions of components in the electronic device 800 may be implemented by a single computing cluster or multiple computing machines, which can communicate through a communication connection. Therefore, the electronic device 800 may be operated in a networking environment using a logical connection with one or more other servers, a network personal computer (PC), or another network node.

The input device 850 may be one or more input devices, such as a mouse, a keyboard, a trackball, etc. The output device 860 may be one or more output devices, such as a display, a speaker, a printer, etc. The electronic device 800 may also communicate with one or more external devices (not shown) through the communication unit 840 as required. The external device, such as a storage device, a display device, etc., communicate with one or more devices that enable users to interact with the electronic device 800, or communicate with any device (for example, a network card, a modem, etc.) that makes the electronic device 800 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of keyword determination, comprising:
presenting an interface comprising a plurality of information fields associated with an object;
in response to detecting completion of input in a first information field among the plurality of information fields, determining at least one candidate keyword for the object based on first information input in the first information field, the first information comprising at least one of: text or visual information; and
presenting the at least one candidate keyword for selection into at least one of the plurality of information fields.

2. The method of claim 1, further comprising:
in response to detecting completion of input in a second information field among the plurality of information fields, updating the at least one candidate keyword based on second information input in the second information field and the first information; and
replacing the presenting of the at least one candidate keyword with presenting of the at least one updated candidate keyword.

3. The method of claim 1, further comprising:
in response to detecting an update of the first information in the first information field, updating the at least one candidate keyword based on the updated first information; and
replacing the presenting of the at least one candidate keyword with presenting of the at least one updated candidate keyword.

4. The method of claim 1, wherein the first information comprises both the text and the visual information, and wherein determining at least one candidate keyword comprises:
extracting a text feature representation of the text and a visual feature representation of the visual information, respectively;
determining a fused feature representation for the object by fusing the text feature information and the visual feature information; and
determining the at least one candidate keyword based on the fused feature representation.

5. The method of claim 4, wherein determining the fused feature representation comprises:
performing an attention mechanism on the text feature representation and the visual feature representation, to obtain an interaction matrix between the text feature representation and the visual feature representation;
determining a text weight corresponding to the text feature representation and a visual weight corresponding to the visual feature representation based on the interaction matrix; and
performing a weighted fusion on the text feature representation and the visual feature representation based on the text weight and the visual weight, to obtain the fused feature.

6. The method of claim 4, wherein determining the at least one candidate keyword based on the fused feature representation comprises:
determining respective similarities between the object and respective keywords in a set of keywords based on the fused feature representation and respective text feature representations of the respective keywords; and
determining the at least one candidate keyword from the respective keywords based on a ranking result of the respective similarities.

7. The method of claim 6, wherein at least part of the set of keywords are generated by a content generative model.

8. The method of claim 1, further comprising:
in response to detecting an attribute value input in an attribute filed among the plurality of information fields, supplementing, using a language model, the attribute value; and
determining the at least one candidate keyword comprises:
determining the at least one candidate keyword based on the first information and the supplemented attribute value.

9. The method of claim 1, further comprising:
in response to the selection, inputting the selected keyword into the at least one of the plurality of information fields.

10. The method of claim 1, wherein the plurality of information fields comprise at least one of: a title field for the object, or a description field for the object.

11. An electronic device, comprising:
at least one processing unit; and
at least one memory coupled to the at least one processing unit and storing instructions executable by the at least one processing unit, the instructions, upon execution by the at least one processing unit, causing the electronic device to perform operations comprising:
presenting an interface comprising a plurality of information fields associated with an object,
in response to detecting completion of input in a first information field among the plurality of information fields, determining at least one candidate keyword for the object based on first information input in the first information field, the first information comprising at least one of: text or visual information; and
presenting the at least one candidate keyword for selection into at least one of the plurality of information fields.

12. The electronic device of claim 11, the operations further comprising:
in response to detecting completion of input in a second information field among the plurality of information fields, updating the at least one candidate keyword based on second information input in the second information field and the first information; and
replacing the presenting of the at least one candidate keyword with presenting of the at least one updated candidate keyword.

13. The electronic device of claim 11, the operations further comprising:
in response to detecting an update of the first information in the first information field, updating the at least one candidate keyword based on the updated first information; and
replacing the presenting of the at least one candidate keyword with presenting of the at least one updated candidate keyword.

14. The electronic device of claim 11, wherein the first information comprises both the text and the visual information, and wherein determining at least one candidate keyword comprises:
extracting a text feature representation of the text and a visual feature representation of the visual feature information, respectively;
determining a fused feature representation for the object by fusing the text feature information and the visual feature information; and
determining the at least one candidate keyword based on the fused feature representation.

15. The electronic device of claim 14, wherein determining the fused feature representation comprises:
performing an attention mechanism on the text feature representation and the visual feature representation, to obtain an interaction matrix between the text feature representation and the visual feature representation;
determining a text weight corresponding to the text feature representation and a visual weight corresponding to the visual feature representation based on the interaction matrix; and
performing a weighted fusion on text feature representation and visual feature representation based on the text weight and the visual weight, to obtain the fused feature.

16. The electronic device of claim 14, wherein determining the at least one candidate keyword based on the fused feature representation comprises:
determining respective similarities between the object and respective keywords in a set of keywords the based on the fused feature representation and respective text feature representations of the respective keywords; and
determining the at least one candidate keyword from the respective keywords based on a ranking result of the respective similarities.

17. The electronic device of claim 16, wherein at least part of the set of keywords are generated by a content generative model.

18. The electronic device of claim 11, the operations further comprising:
in response to detecting an attribute value input in an attribute filed among the plurality of information fields, supplementing, using a language model, the attribute value; and
determining the at least one candidate keyword comprises:
determining the at least one candidate keyword based on the first information and the supplemented attribute value.

19. The electronic device of claim 11, the operations further comprising:
in response to the selection, inputting the selected keyword into the at least one of the plurality of information fields.

20. A non-transitory computer readable storage medium having computer executable instructions stored thereon, the computer executable instructions, when executed by an electronic device, causing the electronic device perform operations comprising:
presenting an interface comprising a plurality of information fields associated with an object,
in response to detecting completion of input in a first information field among the plurality of information fields, determining at least one candidate keyword for the object based on first information input in the first information field, the first information comprising at least one of: text or visual information; and
presenting the at least one candidate keyword for selection into at least one of the plurality of information fields.
